(19) United States
(12) Patent Application Publication
(10) Pub. No.: US 2017/0039741 A1
(43) Pub. Date: Feb. 9, 2017

(54) MULTI-DIMENSIONAL VISUALIZATION

(71) Applicant: SAP SE, Walldorf (DE)

(72) Inventors: Vidur Shailendra Bhatnagar, Roorkee (IN); Nachiket Vinaya, Bangalore (IN); Amit Kumar Singh, Varanarasi (IN); Shailesh Borkar, Gondia (IN); Shivendra Soni, Lucknow (IN); Ankush Mehta, Faridabad (IN); Vidya Gugnani, Bangalore (IN); Gaurav Jain, Bangalore (IN)

(73) Assignee: SAP SE, Walldorf (DE)

(21) Appl. No.: 14/866,562

(22) Filed: Sep. 25, 2015

(30) Foreign Application Priority Data
Aug. 6, 2015 (IN) 4107/CHE/2015

(51) Int. Cl. G06T 11/20; G06T 3/40; G06Q 40/00; G06T 11/60

(52) U.S. Cl. CPC G06T 11/206; G06T 11/60; G06T 3/40; G06Q 40/12

(57) ABSTRACT

Innovations for computer-aided data visualizations are presented. A computer-aided data visualization is generated from data representing a plurality of measures. Example computer-aided data visualizations include a first enhanced graphical element. The first enhanced graphical element conveys information regarding a first derived measure, a first intrinsic measure, and a second derived measure or a second intrinsic measure from among the plurality of measures.

### CROSS REFERENCE TO RELATED APPLICATION

This application claims priority to, and incorporates by reference, India Provisional Patent Application No. 4107/CHE/2015 filed Aug. 6, 2015.

### BACKGROUND

As computer hardware and software become increasingly advanced, the amount of data collected about a variety of things has grown substantially. Analytics software has been increasingly used to analyze and interpret such large amounts of data. Visualization applications, for example, can provide graphical representations of different aspects of data, such as measures or dimensions, to allow a user to easily understand complicated relationships. However, a single, typical visualization only allows a limited number of dimension or measures of the data to be viewed.

### SUMMARY

Generally, the detailed description is directed to innovative approaches to computer-aided data visualization that allow for simultaneous viewing of multiple data dimensions. The disclosed approaches to computer-aided data visualization can provide a number of advantages. For example, they may allow for larger amounts of data to be represented in a single display more intelligibly. This may allow for additional insights to be obtained from the computer-aided data visualizations versus prior techniques that either presented less data or provided data in more complex, less understandable formats. The approaches to computer-aided data visualization also may allow a user's view of, and interaction with, the data to be less dependent on filtering, whether performed by an application or another individual. That is, the approaches to computer-aided data visualization can make the data more amenable to interpretation without requiring such filtering.

According to one innovative aspect of the present disclosure, data representing a plurality of measures are received, such as by a component of a data visualization architecture. A data visualization is generated, such as by a component of the data visualization architecture. The computer-aided data visualization includes at least a first enhanced graphical element that conveys information regarding a first derived measure, a first intrinsic measure, and a second derived measure or a second intrinsic measure from among the plurality of measures.

Information may be conveyed by the enhanced graphical element in a variety of ways. In one implementation, information is conveyed by the shading, coloring, patterning, sizing, or shaping of the first enhanced graphical element. The first enhanced graphical element, in some implementations, is depicted as having a plurality of subsections. One or more of the subsections may provide additional information, including through the use of shading, coloring, patterning, sizing, or shaping of the subsections. In a specific example, the relative size of the subsections compared to one another is used to convey in formation.

In one aspect, information is conveyed by the relative placement of the first enhanced graphical element. For example, the relative placement of the first enhanced graphical element relative to an axis may be used to provide information. In another example, the computer-aided data visualization includes a second enhanced graphical element and the relative positions of the first enhanced graphical element and the second enhanced graphical element convey information.

The computer-aided data visualization may be responsive to user input. For example, the computer-aided data visualization may zoom in on an area of interest in response to user input, such as a click and scroll input with a pointing device. In another example, the computer-aided data visualization displays information, such as measures related to the data, in response to user input. The computer-aided data visualization progressively cycles through a number of relevant measures in response to user input, such as clicks with a pointing device, in a specific example.

In a specific implementation of the disclosed computer-aided data visualizations, the computer-aided data visualization conveys an affinity analysis. As opposed to prior affinity analysis visualizations, affinity analysis visualizations according to an embodiment of the present disclosure can display both an overall association rule and measures or dimensions of the components of the association rule. For example, the computer-aided data visualization can display the total value of a shopping basket represented by the association rule, the individual products in the shopping basket, and the price of the individual products in the shopping basket.

As described above, enhanced graphical elements can be used in the computer-aided data visualization. For example, the size of the enhanced graphical element can be used to represent a property of the association rule, such as the total value of a shopping bag. The relative placement of the enhanced graphical element can be used to convey a dimension or measure of the association rule. For example, its placement relative to an axis or other point on the visualization can be used to indicate the strength of the association, such as the lift value.

Enhanced graphical elements can be displayed having subsections, with each subsection helping to convey a dimension or measure relevant to the affinity analysis. For example, subsections may represent component products in a shopping bag representing a particular association rule. The subsections may be visually differentiated by one another by their size, shape, shading, coloring, or patterning. The relative size of the subsections to one another may be used to convey the proportional value of the component products relative to the overall bag value, or another measure or dimension of the data. In a particular example, the subsections are displayed in the form of a treemap.

The affinity analysis visualization may be responsive to user input. For example, the affinity analysis visualization may zoom in on, or otherwise enhance, an area of interest in response to user input, such as a click and scroll executed with a pointing device. The affinity analysis visualization may also display values associated with the data, such as the values for various displayed measures, in response to user input. For example, the affinity analysis visualization may be caused to display information such as the identity of an association rule, the value of an association rule, the identity of components of the association rule, the individual values of components of the association rule, or the lift of the association rule.

In another specific implementation of the disclosed approaches to computer-aided data visualization, the computer-aided data visualization conveys a loss of sales analysis due to an out of stock situation. As opposed to typical loss-of-sales visualizations, a loss-of-sales visualization according to one embodiment of the present disclosure can convey more measures or dimensions and convey information in a more readily assimilated format.

An enhanced graphical element can be used to convey measures and dimensions associated with stock. For example, the size of an enhanced graphical element can be used to represent stock shortage. The placement of the enhanced graphical element can be used to convey the actual stock quantity and the forecasted stock quantity. In a specific example, the enhanced graphical element has an end placed relative to an axis or similar reference point to indicate the actual stock quantity.

Similarly, an enhanced graphical element can be used to convey measures and dimensions associated with sales. For example, the size of the enhanced graphical element can be used to represent lost sales. The placement of the enhanced graphical element can be used to convey the actual sales and the forecasted sales. In a specific example, the enhanced graphical element has an end placed relative to an axis or similar reference point to indicate the actual sales value.

The relative position of enhanced graphical elements representing stock and sales information can be used to help convey information. For example, the enhanced graphical elements can be positioned relative to an axis or similar reference point to indicate that the enhanced graphical elements are associated with the same item. In another example, the enhanced graphical elements convey increasing values relative to a common reference point.

The loss-of-sales visualization may convey additional information in response to user input. For example, the loss-of-sales visualization may zoom or otherwise enhance an area of interest in response to user input, such as in response to a click and scroll executed with a pointing device. In another example, the loss-of-sales visualization displays information, such as the values of measures associated with the loss-of-sales visualization, in response to user input, such as a click with a pointing device. User input may be used to cycle through displaying values for actual stock, forecasted stock, and stock shortage and values for actual sales, forecasted sales, and lost sales.

The above described computer-aided data visualizations may be carried out in any suitable data visualization architecture. In a specific example, the data visualization architecture includes a flow control module, a calculation engine, and a data repository, such as one or more of metadata storage, an online analytical processing database, and a relational database management system. The flow control module receives queries from the visualization engine and forwards them to the calculation engine. The flow control module forwards formatted results of the queries to the visualization engine.

Another example of a data visualization architecture includes a desktop application, such as a data visualization tool, and an operating system. The desktop application includes a container, a cache, and an embedded server. The container includes a rendering engine useable to generate visualizations according to an embodiment of the present disclosure. In particular examples, the container builds a document object model for dynamic content associated with a computer-aided data visualization.

The embedded server retrieves resources on behalf of the desktop application, including the container. The resources may include information corresponding to measures or dimensions for the computer-aided data visualization. Certain resources may be stored in the cache to reduce processing times, particularly when the information has not changed since being cached.

The innovations can be implemented as part of a method, as part of a computing system adapted to perform the method, or as part of non-transitory computer-readable media storing computer-executable instructions for causing a computing system to perform the method. The various innovations can be used in combination or separately. The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an example software architecture of a system for implementing visualizations according to an embodiment of the present disclosure.

FIG. 2 is a block diagram of an alternative example software architecture of a system for implementing visualizations according to an embodiment of the present disclosure.

FIG. 3 illustrates an embodiment of a visualization according to the present disclosure.

FIG. 4 is a diagram illustrating operations when generating a visualization according to an embodiment of the present disclosure.

FIG. 5 illustrates a specific example of the visualization of FIG. 3.

FIG. 6 illustrates an alternative specific example of the visualization of FIG. 3.

FIG. 7 is a diagram illustrating a generalized implementation environment in which some described examples can be implemented.

### DETAILED DESCRIPTION

Computer-aided data visualizations can provide easy-to-understand, graphical representations of data that may be useful for data analysis. Computer-aided data visualizations are often used to assist in summarizing and visualizing data. Common computer-aided data visualizations include line, bar, and pie charts. While these standard visual aids can be helpful in many scenarios, they typically become less helpful as the volume or complexity of the data increases, such as when multiple aspects of the data need to be visually represented simultaneously in order for conclusions to be easily drawn from the computer-aided data visualizations.

In many situations, such as in large companies, computer-aided data visualizations are often used for decision-making purposes, such as by senior executives. Many times, the visual representations of the data are prepared for the senior executives by others. In such situations, not only may standard visualizations not clearly allow trends to be seen so that optimal decisions can be made, but also the decision-maker may have little to no knowledge of the data used to construct the computer-aided data visualization. The chance for drawing incorrect or suboptimal conclusions is thus increased.

Computer-aided data visualizations typically portray one or more dimensions. A dimension refers to a perspective on data, including measures associated with the data. For example, in analyzing sales of a product, a user may wish to view sales by country, region (such as by a state), city, or by individual transactions. “Dimension,” used in this context, does not necessarily refer to a geometric dimension such as a measurement of height, width, or length. Similarly, “dimensional” does not necessarily refer to the typically understood state of being one-dimensional, two-dimensional (2D), or three-dimensional (3D). A multi-dimensional visualization means that the computer-aided data visualization simultaneously conveys information regarding multiple dimensions (ways of perceiving data).

Computer-aided data visualizations typically also provide information representing one or more measures. A measure is a numerical value that provides meaning to a dimension, and can be subjected to calculations. However, the representation of the measure need not be numerical. For example, the numerical value of the measure can be converted into a qualitative descriptor (high/low, for example), and can be graphically represented qualitatively and/or quantitatively, as will be further described.

Often, dimensions can be considered, or viewed, hierarchically, such as from a more encompassing level to a more narrow, granular level. In the above example using regional dimensions, “city” may be considered a more granular level than “state.”

Typically, measures can also be represented as a dimension, even if the dimension is fairly granular. However, not all dimensions are measures. For example, while “sales” can be subjected to calculations (that is, a measure), and can be a way of perceiving data (that is, a dimension), a dimension such as “sales by state” cannot be directly calculated from underlying sales data by itself (in which case, “sales by state” is not a measure). On the other hand, even though calculation can be performed on sales data, the measure “sales” may be “dependent” in the sense that its meaning depends on the context, or dimension of interest. For example, the value represented by the measure “sales” is dependent, will change, depending on if the dimension is sales by country, by region, by city, etc. However, “sales” could be both the measure and the dimension, in which case “sales” is likely to be at the dimensional granularity of individual transactions.

Measures may be intrinsic measures. Intrinsic measures are those that are an inherent, pre-existing feature of the data under observation. For example, for data representing product sales, the price of the product is an intrinsic measure. Measures may also be derived. Derived measures are those produced from the intrinsic measures, such as by performing calculations using, or analysis of, the intrinsic measures. For example, sales over time may be analyzed to generate the profit or loss of a business over time. Because profits and losses can be the subject of further calculations, they are a measure in addition to representing a dimension. In some cases, whether the measure is intrinsic or derived depends on the circumstances of the visualization. For example, if data was provided regarding the final cost of goods for a product, that would be an intrinsic measure. However, if data was provided and then used to calculate the cost of goods, the cost of goods would be a derived measure in that context. Similarly, a derived measure, if saved as part of the data under observation, can be an intrinsic measure for purposes of later visualization.

In another aspect, intrinsic measures and derived measures relate to a particular dimension of data. Intrinsic measures can be viewed as more granular measures than derived measures. In the above example of sales over time, sales over time is more granular than the profit or loss of the business over time. Thus, sales over time may be considered an intrinsic measure and the profit or loss of the business over time may be considered a derived measure.

### I. Example Architectures for Multi-Dimensional Visualization

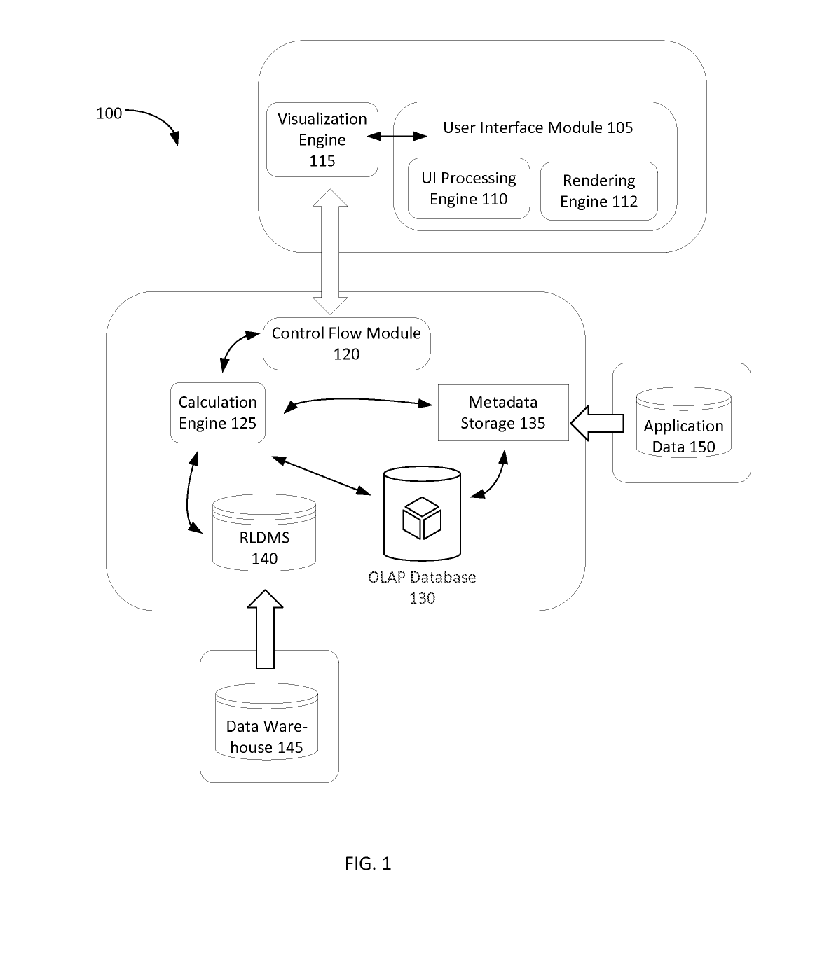

FIG. 1 illustrates an example architecture 100 that may be used to implement visualizations according to an embodiment of the present disclosure. The architecture 100 includes a user interface module 105. The user interface module 105 includes a user input processing engine 110. The user interface module 105 is in communication with a visualization engine 115.

The visualization engine 115 interacts with (e.g., receives user input events from) the user interface module 105. The visualization engine 115 is in communication with a control flow module 120. The control flow module 120 may be in communication with a calculation engine 125, which is in communication with one or more of an online analytical processing (OLAP) database 130, metadata storage 135, and a relational database management system (RLDMS) 140. The metadata store 135 and RLDMS 140 are in communication with one or more data sources, such as a data warehouse 145 and application data 150, respectively.

The user input processing engine 110 receives user input, including user input regarding visualization criteria, such as datasets to be queried and measures and dimensions selected for visualization. The user input processing engine 110 also receives user input for manipulating a visualization, such as panning around the visualization, zooming in/out to different levels of detail for the visualization, selecting an element, and/or otherwise manipulating the display. In a specific example, the user input is received in the form of movement and selection (such as mouse clicks) from a pointer device.

A rendering engine 112 of the user interface module 105 receives data, such as display instructions or commands, graphics primitives, etc., from the visualization engine 115, converts it to a visualization, and displays the visualization to a user. The rendering engine 112 of the user interface module 105 may modify some aspects of the visualization in response to user input received by the user input processing engine 110. In other examples, the user input is processed by the visualization engine 115, which sends updated data to the rendering engine of the user interface module 105 to update the displayed visualization.

The visualization engine 115 sends data requests to the control flow module 120. The control flow module 120 receives the requests and forwards them to the calculation engine 125. The calculation engine 125 in turn requests appropriate data from the OLAP database 130, metadata storage 135, and/or RLDMS 140. The calculation engine 125 then performs appropriate extractions, interpretations, or calculations on the data and transmits the results as formatted metadata to the flow control module 120, which in turn forwards results of the queries to the visualization engine 115. For example, the calculation engine 125 may generate derived measures from data obtained from the OLAP database 130, metadata storage 135, or RLDMS 140, or the calculation engine 125 may forward such data as intrinsic measures.

OLAP database 130, metadata storage 135, and RLDMS 140 receive and process data from data sources that may include data warehouse 145 and application data 150.

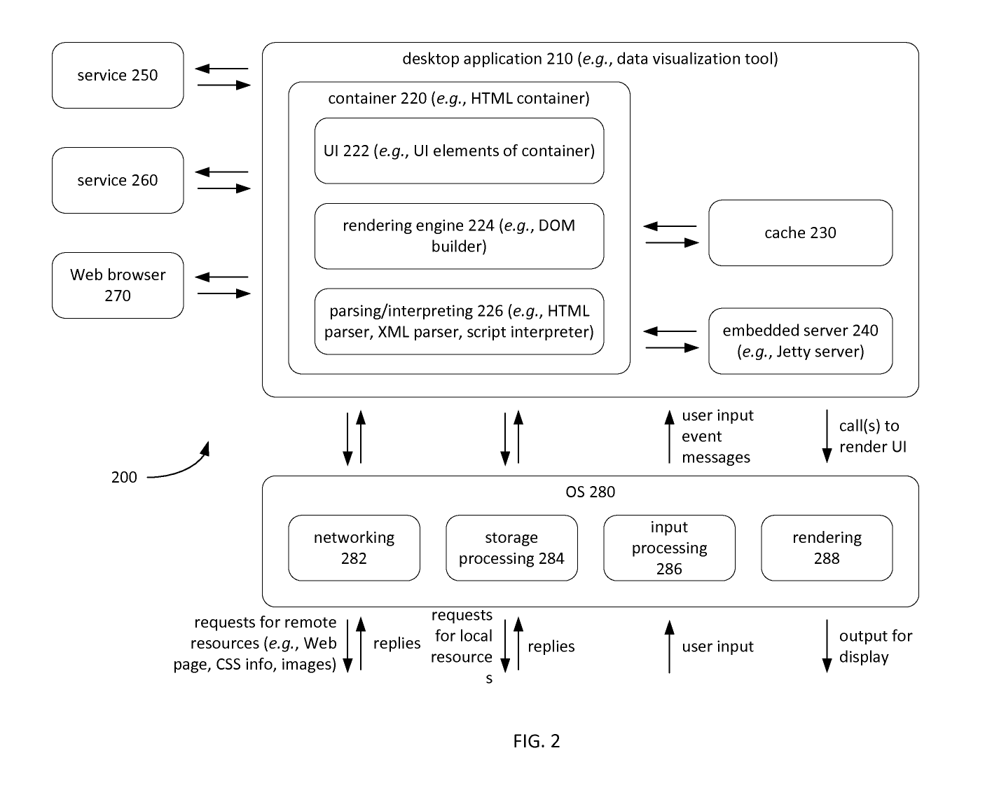

FIG. 2 shows an alternative example software architecture 200 that may be used to generate visualizations according to an embodiment of the present disclosure. A computing system (e.g., smartphone, tablet computer, personal computer, or other computing system) can execute software organized according to the architecture 200.

The architecture 200 includes an operating system (OS) 280, a desktop application 210 that uses services of the OS 280, two other application-level services 250, 260, and a Web browser 270. In FIG. 2, the OS 280 includes components for rendering (e.g., rendering visual output to a display), components for networking, components for reading from/writing to storage, and components for input processing. Other components of the OS 280 are not shown. In general, the OS 280 manages user input functions, output functions, storage access functions, network communication functions, and other functions for the computing system. The OS 280 provides access to such functions to the desktop application 210 and other software running on the computing system (e.g., the other application-level services 250, 260 and/or the Web browser 270.

In a networking module 282 of the OS 280, the OS 280 conveys requests for data and/or remote resources (such as Web pages, style sheet information, images) to one or more remote servers. The networking module 282 receives replies to the requests. The replies can provide, for example, various types of data and/or resources. The desktop application 210 can request a dynamic Web page for an application. The dynamic Web page provides functionality for the user interface (UI) of the desktop application 210, as described herein. In some special cases, however, the desktop application 210 may request a static Web page for the application.

In a storage processing module 284 of the OS 280, the OS 280 conveys requests for data and/or local resources (such as Web pages, style sheet information, images, strings or other language-specific or locale-specific information) to one or more local databases. The storage processing module 284 receives replies to the requests. The replies can provide, for example, data and/or local resources in a local database or the cache 230. The returned resources may be integrated into the desktop application 210 when rendered.

A user generates user input, which can be tactile input such as touchscreen input, mouse input, button presses or key presses, or can be voice input. In an input processing module 286 of the OS 280, the OS 280 includes functionality for recognizing taps, gestures, or other input to a touchscreen, recognizing commands from voice input, mouse input, button input or key press input, and creating messages that can be used by the desktop application 210. Through the container 220, the desktop application 210 listens for user input event messages from the OS 280. The user input event messages can indicate a gesture or tap on a touchscreen, mouse input, key press input, or another user input event (e.g., from voice input, directional buttons, trackball input). If appropriate, the desktop application 210 can react to the user input (or another type of notification) by making one or more calls to the OS 280 or performing other processing.

In a rendering module 288 of the OS 280, the OS 280 handles call(s) from the desktop application 210 to generate output for display. For example, the rendering module 288 renders a computer-aided data visualization as part of a dynamic Web page or other dynamic content for an application.

The desktop application 210 is, for example, a data visualization tool or business intelligence tool for allowing a user to create, view, or manipulate a computer-aided data visualization according to an embodiment of the present disclosure. Alternatively, the desktop application 210 is some other type of application that allows a user to create, view, or manipulate such a computer-aided data visualization. The desktop application 210 includes a container 220, a cache 230, and an embedded server 240. The container 220 is, for example, an HTML container. The container 220 includes a UI module 222, a rendering engine 224, and a parsing/interpreting module 226. Overall, the container 220 is configured to perform various operations described in this section, including requesting a Web page for an application, requesting data and resources for the application, rendering the Web page (where the rendered Web page includes graphical elements of a UI of the application, and at least some of the elements of the UI are actuatable to launch services), handling user input to the application, and launching one of the services. Overall, the embedded server 240 is configured to perform various operations described in this section, including retrieving the requested data and resources for the application.

The UI module 222 of the container 220 controls UI elements of the container 220 and desktop application 210. For example, the UI module 222 controls menus, scroll bars and other “chrome” features of the desktop application 210 itself.

The rendering engine 224 builds a document object model (“DOM”) for a dynamic Web page or other dynamic content. In general, the DOM represents objects in the dynamic Web page or other dynamic content, as well as ways to interact with such objects. Conventionally, a DOM is organized as a tree structure in which nodes represent objects hierarchically. Objects in the DOM can be addressed, manipulated, or otherwise interacted with using functions defined on the objects. In particular examples, a user interacts with a dynamic Web page or other dynamic content through the DOM to create, view, or manipulate a computer-aided data visualization according to an embodiment of the present disclosure.

The parsing/interpreting module 226 parses and/or interprets code for dynamic Web pages or code for dynamic content, as well as style sheet information, images and other related resources for the dynamic content. The parsing/interpreting module 226 provides results of the parsing/interpreting to the rendering engine 224. The parsing/interpreting module 226 can include an HTML parser, XML parser, and/or other markup language parser. The parsing/interpreting module 226 can also include a JavaScript interpreter and/or other script interpreter. Thus, to render a Web page, the container 220 is configured to: (i) parse markup language code for the Web page (e.g., HTML code and/or XML code), (ii) create a DOM, and/or (iii) interpret script code for the Web page. For example, the Web page is a dynamic Web page defining the UI of the application 210 using HTML elements such as frames and content to be rendered in the frames, as well as scripting code such as client-side JavaScript code.

The cache 230 is configured to store Web pages (e.g., dynamic Web pages) and related resources for the desktop application 210. Before requesting a dynamic Web page or resource, the container 220 can be configured to check whether the cache 230 includes a Web page or resource. The container 220 can also be configured to check whether the Web page or resource has changed since being stored in the cache 230. If the cache 230 contains a current version of the dynamic Web page or resource, the container 220 can use the cached version of the dynamic Web page or resource, avoiding the extra steps of requesting and retrieving the Web page or resource.

The embedded server 240 handles calls from the container 220 to retrieve resources from a local database or other local source. The embedded server 240 retrieves the requested resources, if available, and provides retrieved resources to the container 220. The embedded server 240 is, for example, a Jetty server or other server that provides Web server functionality and/or script servlet functionality (e.g., Java servlet functionality) for the desktop application 210. The container 220 and embedded server 240 can communicate using HTTP or another protocol.

For localization, the container 220 determines a language or locale for the desktop application 210, e.g., based on a setting for the desktop application or preference selection by the user. The embedded server 240 can play a role in localization of the desktop application 210. For example, the embedded server 240 is configured to receive an indication of language or locale (from the container 220) and, based on the indication of language or locale, retrieve strings of text elements of the UI of the application 210. The embedded server 240 is further configured to return the strings to the container 220, which uses the strings when rendering the Web page. If necessary, the application 210 can be re-started to change the language or locale for the application 210.

The container 220 can be configured to, at startup, request an initial version of the Web page from the embedded server 240 and/or request a current version of the Web page from a remote server. For example, when a desktop application that integrates a dynamic Web page is launched, the container 220 and embedded server 240 are started. The application 210 requests the container 220 to open a URL for the dynamic Web page. Initially, the URL can be a local, startup page that the embedded server 240 retrieves from a local database for processing by the parsing/interpreting module 226 of the container 220. The user can also navigate to a home screen of the application 210, which is specified in a dynamic Web page the container 220 retrieves from the cache 230 or a remote server. The container can then parse the dynamic Web page, create a DOM for the dynamic Web page, and execute script code to manage interactions between the user and DOM for the dynamic Web page. The content of the dynamic Web page may subsequently change over time in response to user input or in response to updates from a server (e.g., for a computer-aided data visualization as described below).

After processing by the parsing/interpreting module 226 of the container 220 and rendering by the rendering engine 224 of the container 220, the home screen can show various graphical elements (such as buttons) that a user can actuate to launch services of the desktop application 210. Some of the services can be provide using the Web browser 270, which can also be used to access an arbitrary external Web link in the dynamic Web page. FIG. 2 shows two services 250, 260. Alternatively, the desktop application 210 can be capable of launching more or fewer services. The user can actuate other graphical elements of the home screen to cause the desktop application 210 to perform other operations of the desktop application 210. To handle user input, the container 220 is configured to receive a user input event. The container 220 is further configured to pass the user input event to one of the services or another component of the desktop application 210, or process the user input event in the container 220 (e.g., launching a service, performing a desktop operation). When processing a user input event, the container 220 can call one or more internal methods defined for the DOM.

The UI of the desktop application 210 can change depending on the form factor of the computer system or window size for the application 210. For example, the container 220 is configured to request style sheet information for the application (e.g., from a local database or remote server, after checking the cache 230 for the style sheet information). The style sheet information can specify different layouts for the UI of the application 210 for different form factors or window sizes. The container 220 is also configured to evaluate configuration information for a display device or window (e.g., width and/or height, resolution). To render the Web page, the container 220 is configured to set the layout of the desktop application 210 based on one or more fields (e.g., media tags) of the style sheet information and based on the configuration information for the display device or window.

Alternatively, the OS 280 includes more or fewer modules. Or, the desktop application 210 includes more or fewer modules. A given module can be split into multiple modules, or different modules can be combined into a single module. For example, the container 220 can be implemented as multiple modules, with the parsing/interpreting module 226 being independent of the other modules of the container 220.

### II. Generalized Examples of Multi-Dimensional Visualization

The present disclosure provides visualizations that allow multiple dimensions (including measures being viewed as dimensions) of data to be simultaneously visually represented. In some embodiments, the visualizations allow multiple measures to be simultaneously represented.

At least certain embodiments of the present disclosure provide enhanced graphical elements to help visualize multiple dimensions, multiple measures, or combinations of dimensions and measures of data. In one embodiment, an enhanced graphical element conveys information regarding multiple measures, such as at least three measures. In a specific example, an enhanced graphical element conveys information about at least a derived measure, at least an intrinsic measure, and at least one additional measure, which may be an intrinsic measure or a derived measure.

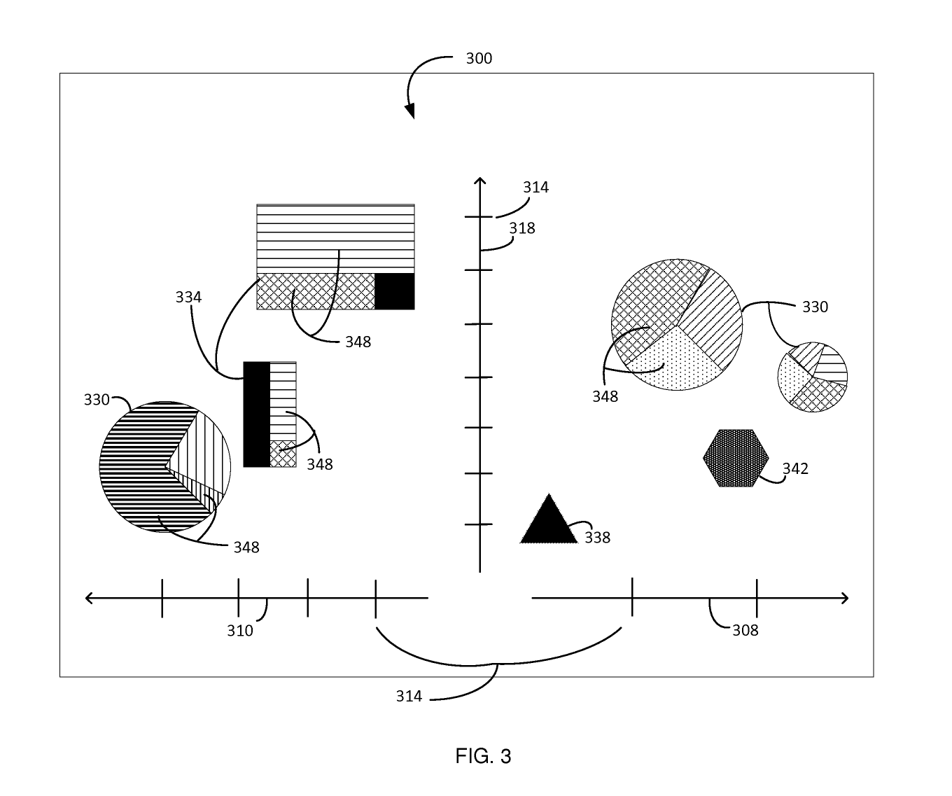

The enhanced graphical element can use one or more features to convey information about the represented measures. FIG. 3 presents an example visualization 300 that represents an embodiment of the present disclosure. The visualization 300 includes horizontal axes 308, 310. In some implementations, the axes 308, 310 represent the same quantity. In other implementations, the axes 308, 310 represent different quantities. Similarly, certain implementations have the axes 308, 310 represent positive and negative values of the same quantity. In other implementations, the axes 308, 310 may convey independent measures or dimensions. For example, axis 308 may track positive values (such as values increasing from left to right) of a first quantity, while axis 310 tracks positive values (such as values increasing from right to left) of a second quantity. Just as the measure or dimension tracked by axis 308 may be the same or different than the measure or dimension tracked by axis 310, the scale of the axes 308, 310 may also differ. In FIG. 3, this is graphically indicated by axis 308 having fewer tick marks 314 than axis 310, but different scales can be indicated in some other way. The number of tick marks 314 may vary between axes 308, 310. In some examples, axes 308, 310 have the same number of tick marks, while in others example one axis will have a greater number of tick marks 314 than the other. In addition, in further examples, one or both axes 308, 310 may not have ticks marks 314. Although FIG. 3 illustrates two axes 308, 310, embodiments of the present disclosure are not required to have axes of any kind, may have more than two axes, or may have an axis oriented other than horizontally.

Implementations of visualization 300 having multiple axes that are separate but in alignment can at least partially provide an enhanced graphic element or enhanced visualization of multiple dimensions, multiple measures, or a combination of dimensions and measures. For example, having two horizontal axes 308, 310 in the same visualization 300 can allow two or more interrelated measures to be simultaneously presented. Having these two measures in close proximity, facilitated by not requiring a single, uniform horizontal axis, can aid in drawing conclusions, identifying trends, or otherwise analyzing the data represented in the visualization 300.

FIG. 3 further illustrates a single vertical axis 318 having tick marks 314. Although an element of visualization 300, embodiments of the present disclosure need not include a vertical axis 318 or may include one more additional vertical axes. While vertical axis 318 is shown extending above the horizontal axes 308, 310, the vertical axis may extend below, or both above and below, the horizontal axes 308, 310, in other implementations.

The use of a vertical axis 318 may further convey further information about the data represented in the visualization 300, including conveying information relating to a measure. In some implementations, the use of a common axis, such as common vertical axis 318, may assist in relating different types of data or different measures. In a specific example, a common vertical axis 318 is used to identify a specific element (such as a product, for example) to which the data or measures relate, thus enhancing the connection between the measures/dimensions conveyed by the horizontal axis 308 and those conveyed by the horizontal axis 310.

As discussed above regarding the horizontal axes 308, 310, certain implementations of visualization 300 omit the vertical axis 318. Thus, some implementations of visualization 300 may not contain any axes. Yet further embodiments include axes other than horizontal or vertical axes, such as a diagonal axis (for example, in a radar plot) or a non-linear axis (for example, in a polar coordinate system).

The visualization 300 further includes a plurality of enhanced graphical elements 330, 334, 338, 342. Each enhanced graphical element 330, 334, 338, 342 may include one or more graphical features that may be used to convey information about a relevant dimension/measure. For example, the overall shape of the elements 330, 334, 338, 342 may represent a dimension or measure. Thus, circular elements 330 may be used to represent a different dimension or measure than that represented by the rectangular shape of element 334. In some implementations, the shape of the element 330, 334 bears a particular relationship to the measure or dimension represented. For example, if the data represented is sales by state, elements 330, 334 may bear the shape of the state whose sales the element represents. In another example, measures or dimensions associated with a car purchase or car rental may have elements 330, 334 bearing the shape of a car to help orient those viewing the visualization as to the meaning, significance, or interpretation of the visualization. In some implementations, when the element 330 or 334 has a shape that is representative of the measure or dimension, the shape can be the same for each element 330, 334, or different. For example, in the case of measures or dimensions associated with automobiles, it may be sufficient for each element 330, 334 to have the shape of an automobile. In other examples, elements 330, 334 may each bear the shape of a different automobile, thus conveying even more detailed information to the viewer. Further examples do not use the shape of the elements 330, 334, 338, 342 as an information-conveying feature.

Other graphical features of elements 330, 334, 338, 342 may be used to impart information. For example, two elements 330 are shown having different sizes, as are the two elements 334. Similarly, the elements 330, 334, 338, 342 may have features such as colors, shadings, patterns, gradients, and the like that serve to provide information, such as information regarding a dimension or measure. In addition, when the visualization 300 includes multiple elements, the relative position of the elements to one another may convey information about a measure or dimension, whether or not the visualization 300 formally includes an axis, as described above.

Elements 330, 334 are shown with a plurality of subsections 348. The subsections 348 may be used to convey additional information regarding elements 330, 334, such as additional related dimensions or measures. Although the elements 330, 334 are shown having multiple subsections 348, the visualization 300 can include elements that do not have multiple subsections, such as elements 338, 342. As with elements 330, 334, 338, and 342, the subsections 348 can have graphical elements such as shape, size, color, shading, patterns, and relative position that provide information regarding one or more measures or dimensions.

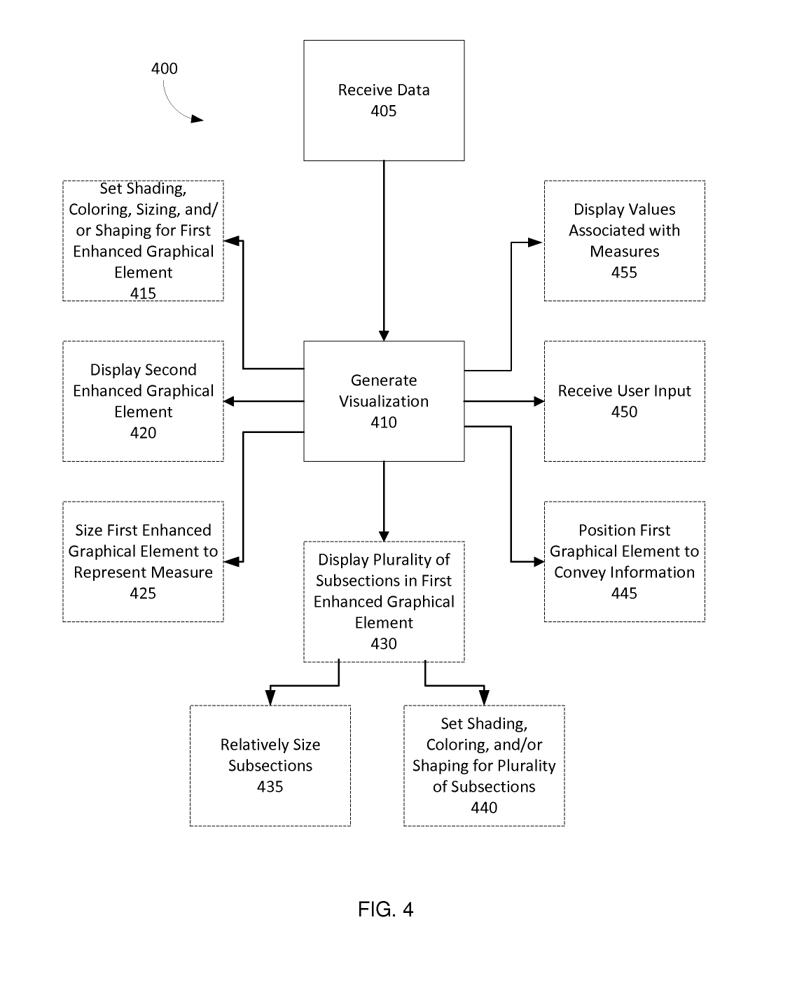

FIG. 4 provides a diagram illustrating operations 400 when generating a visualization according to an embodiment of the present disclosure. In stage 405, data are received representing a plurality of measures. In stage 410, a data visualization is generated that includes at least a first enhanced graphical element conveying information regarding a first derived measure, a first intrinsic measure, and a second derived measure or a second intrinsic measure among the plurality of measures. Stages 415, 420, 425, 430, 435, 440, 445, 450, and 455 are examples of options when generating the data visualization during stage 410, which may include one or more of stages 415, 420, 425, 430, 435, 440, 445, 450, and 455.

In some cases, information is conveyed by setting properties of shading, coloring, sizing, and/or shaping for the first enhanced graphical element, in stage 415. In some cases, the operations 400 include the stage 420 of displaying at least a second enhanced graphical element and placing it on the visualization relative to the first enhanced graphical element in a way that conveys information regarding a measure or dimension of the data. One implementation of the operations 400 generate a visualization in stage 410 representing loss of sales resulting from a stock shortage. In this implementation, first and second enhanced graphical elements may be placed proximate one another so that the visualization conveys both loss of sales and shortage of stock for the same product or products. In a specific example, both the first and second enhanced graphical element are associated with an axis that conveys increasing values relative to a common reference point.

In optional stage 425, the first enhanced graphical element is sized to represent one of the measures conveyed by the first enhanced graphical element. In particular implementations, the data visualization conveys information about an affinity analysis. In these implementations, generating a data visualization in stage 410 includes using a first enhanced graphical element representing an association rule and being sized to represent a measure of the association rule. In a more specific example, the measure the graphical element is sized to represent the total cost of a plurality of products in the association rule. When the operations 400 are used to convey loss of sales resulting from a stock shortage, sizing the first enhanced graphical element to convey a measure in stage 425 is used to convey an amount of stock shortage or an amount of lost sales.

In other examples of the visualization generated in stage 410, the first enhanced graphical element is displayed with a plurality of subsections in stage 430. In a particular example, operations 400 size subsections in stage 435 to represent the relative contribution of each component to a measure conveyed by the first enhanced graphical element. In a particular implementation, the first enhanced graphical element and its subsections form a treemap.

In a specific example where the visualization generated in step 410 conveys an affinity analysis, the subsections represent individual products in an association rule and are sized in stage 435 to represent the relative cost of a product in the product combination represented by the first enhanced graphical element.

Optionally, in stage 440, the subsections are visually distinguished from one another in a manner other than, or in addition to, their relative size. For example, the subsections may be displayed in different colors, shadings, patterns, and/or shapes. In the particular example of an affinity analysis, the color, shading, pattern, and/or shape of each subsection may be used to help identify the particular product represented by the subsection.

Some examples of the operations 400 include a stage 445, where the first enhanced graphical element is positioned on the visualization to convey a measure associated with data represented by the first enhanced graphical element. For example, when the visualization generated in stage 410 conveys an affinity analysis, the enhanced graphical element may be positioned to represent the lift of an association rule. When the visualization generated in stage 410 conveys loss of sales due to an out of stock situation, the size and position of the first enhanced graphical element may be used to convey a quantity of actual stock, a quantity of forecasted stock, and a quantity of shortage of stock. Similarly, the size and position of the first graphical element may be used to convey an amount of actual sales, an amount of possible sales, and an amount of lost sales.

In some examples, the operations 400 include a stage 450 of receiving user input to manipulate the visualization generated in stage 410. In a specific example, the input received in stage 450 is input from the user to zoom in on a portion of the visualization. The user may, for example, scroll with a pointing device to indicate that the visualization should enlarge a particular area of the visualization in stage 450. The user input may also be, for example, a selection by clicking with a pointing device, so as to cause display of information associated with the visualization generated in stage 410. For example, the user may request values associated with various measures to be displayed on the visualization.

Accordingly, certain examples of the operations 400 also include the stage 455 of displaying values related to the measures in the visualization generated in stage 410. The values are displayed in response to user input, in particular examples. In one example, the display cycles through a series of values, such as values associated with different measures, in response to user input. When the visualization generated in stage 410 represents lost sales from being out of stock, for example, the user may cycle through values for actual stock, forecasted stock, and stock shortage, or through values for actual sales, possible sales, and lost sales.

The innovative visualizations of the present disclosure will be further detailed by describing two specific implementations of the visualization 300.

### III. First Implementation of Multi-Dimensional Visualizations

In the retail industry, an affinity analysis or market basket analysis is commonly used by those seeking to understand the purchasing behavior of retail store customers. This information can be useful for a number of reasons, such as to maximize cross-selling opportunities and to identify products and product relationships that may increase profits. In an example of the affinity analysis, the retailer is trying to find out what products are sold together. For example, if a customer purchases shampoo, it is likely that the customer will also purchase conditioner. In this example, shampoo is the driver product and conditioner is the driven product.

Association rule mining algorithms may be used to extract affinity information from sales data. One popular algorithm is APRIORI, which is implemented as part of the Predictive Analytics Library (PAL) of the HANA database platform of SAP SE of Waldorf, D E. The association rule mining algorithms typically are used to identify rules that define what products are sold together based on the associations between antecedents (driver products) and consequents (driven products). In addition to association rule(s), the algorithm may provide metrics that can be used to evaluate the accuracy or significance of the rule(s). The metrics can include confidence, support, and lift. The metric “confidence” signifies the proportion of transactions involving one or more products that involve one or more additional products. For example, if bread is purchased in three of five transactions where jam was purchased, the confidence of bread being purchased with jam is ⅗, or 0.6. The metric “support” indicates the proportion of the transactions in the database where the items in the association rule are sold together. For example, a support value of 0.25 indicates that the combination occurs in twenty-five percent of all the transactions. The metric “lift” is calculated as the support for a combination of items divided by the product of the support for the individual items in the combination. While higher support and confidence values may also indicate a strong association, lift is typically a more useful measure. As with support and confidence, higher lift values indicate that the particular rule occurs more frequently.

### A. Example Affinity Analysis.

For affinity analysis, a data analysis tool can perform the following steps. The data analysis tool loads data into a database, such as an OLAP database. The data may include, for example, transactional data, such as point of sales data. A predictive algorithm, such as APRIORI, is applied to the data. In a specific example, the output of the predictive algorithm is association rules, including metrics such as confidence, support, and lift. Example output is shown in Table 1, below.

TABLE 1
Example association rules and corresponding derived measures.

| RULE | LIFT | CONFIDENCE | SUPPORT |
|---|---|---|---|
| Bread->(Butter, Jam) | 15 | 0.81 | 0.75 |
| Beer->Diapers | 10 | 0.79 | 0.92 |
| Milk->(Cookies, Cornflakes) | 4 | 0.78 | 0.56 |

Table 1 illustrates three separate association rules, along with their corresponding values for metrics of lift, confidence, and support. The “bread” rule has a higher confidence and lift than the “beer” and “milk” rules. The “beer” rule has higher lift, confidence, and support values than the “milk” rule. Thus, the association rules reveal three product combinations that are likely to be sold together, with the “bread” rule being the most likely combination to be sold together, the “beer” combination being the next most likely, followed by the “milk” combination.

Each rule is then segmented by the elements making up the rule. For example, when the rule defines products that are typically purchased together, the segmentation may individually list all the products and values such as the lift associated with the combination, the individual price of the component products, and the total price of all the products in the combination. If desired or appropriate, certain metrics, measures, or data may be omitted in subsequent analysis. For example, further analysis may involve only the “lift” measure, which is typically more meaningful than “confidence” or “support.” Example output is shown in Table 2, below.

TABLE 2
Example association rules and corresponding intrinsic and derived measures.

| BAGID | ITEMS | LIFT | PRICE | TOTAL PRICE |
|---|---|---|---|---|
| 1 | Bread | 15 | 10 | 50 |
| 1 | Butter | 15 | 25 | 50 |
| 1 | Jam | 15 | 15 | 50 |
| 2 | Beer | 10 | 75 | 175 |
| 2 | Diapers | 10 | 100 | 175 |
| 3 | Milk | 4 | 30 | 100 |
| 3 | Cookies | 4 | 20 | 100 |
| 3 | Cornflakes | 4 | 50 | 100 |

Table 2 illustrates three separate association rule results, called BAGIDs in Table 2, that represent products that are typically sold together. Table 2 lists the individual products in each bag, along with the lift value for each bag, the price of each item in the bag, and the total bag price. For example, the association rule for BAGID 1 reveals that bread, butter, and jam are typically sold together. The product combination has a lift value of 14 and a total price of 50. The total price is given by the sum of the individual product prices, 10 for bread, 25 for butter, and 15 for jam.

### B. Visualizing Results of Affinity Analysis.

While the affinity analysis is a useful tool, its usefulness may be limited by the visualizations available to represent it. Typically, decision-makers use a tag-cloud visualization to visualize two dimensions of the data—the association (antecedents and consequents) information as the nearby words (shampoo and conditioner, for example), and the lift value, represented as the size of the words. However, this visualization is not typically able to capture additional dimensions or measures associated with the data. For example, the visualization does not provide information regarding the price of the associated products, nor does it provide the total cost of the associated products. The only information that the user is able to glean from the tag-cloud visualization is whether or not there is a high probability of a set of products being sold together. It may be difficult to make practical decisions based on a tag-cloud visualization, for example, when two or more rules have similar lift values. While this data regarding individual and total price is typically available, prior visualizations have not provided a way to simultaneously view more of these different measures and dimensions simultaneously in a way that is easily understandable by a user.

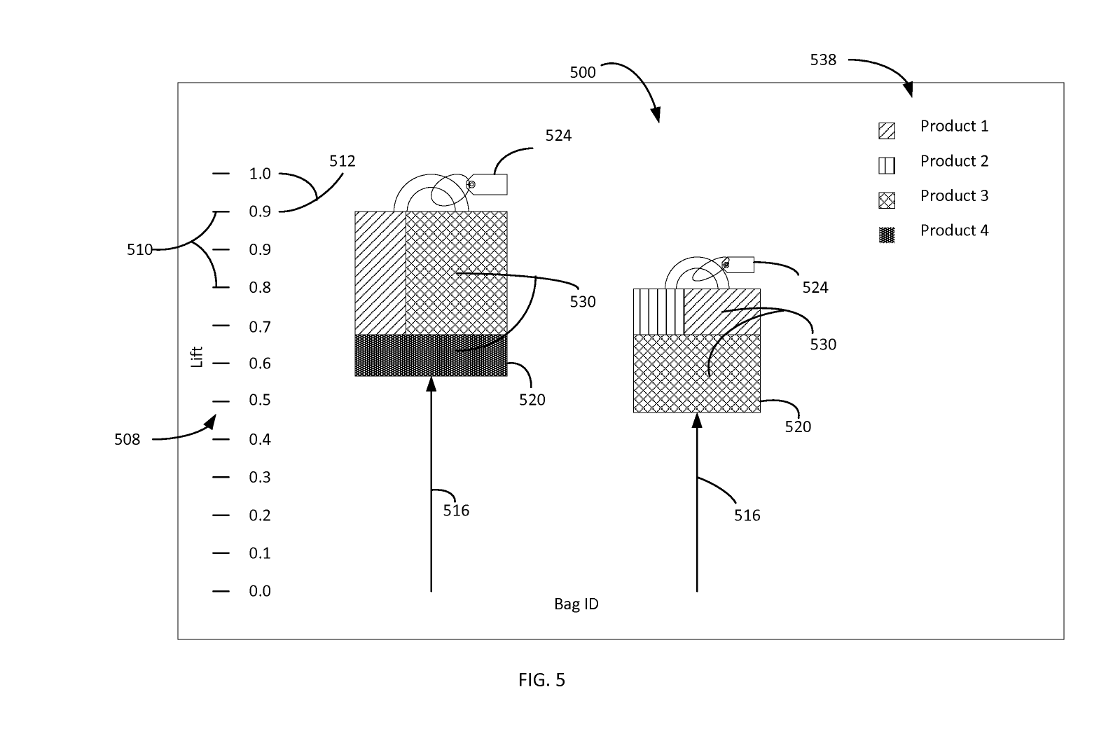

FIG. 5 presents an improved affinity analysis visualization 500 that represents a particular implementation of the visualization 300 of FIG. 3. Visualization 500 has a vertical axis 508 having a plurality of tick marks 510. Each tick mark 510 displays a value 512 representing the amount of lift of a particular association rule/product combination. Vertical arrows 516 extend from the zero lift value to the bottom of enhanced graphical elements 520. Each enhanced graphical element 520 represents a particular association rule/product combination. The length of the arrows 516 indicates the lift for the particular enhanced graphical element 520. The lift values can be normalized (e.g., to a range of 0.0 to 1.0) or have raw values.

While FIG. 5 does not include an explicit horizontal axis, one could be provided if desired. A horizontal axis may be used, for example, to convey the identity of a particular product combination (such as a Bag ID). Or, the bags could be placed in order, such as from maximum to minimum lift, or by maximum to minimum total product value, for example. Of course, the horizontal position of elements on the visualization 500 may be used to convey other dimensions or measures. In other examples, the horizontal position of the enhanced graphical elements 520 may not be significant.

Each enhanced graphical element 520 includes features that provide additional information compared with prior visualizations such as tag-clouds. One such feature is the size of the enhanced graphical elements 520. The overall size of each enhanced graphical element 520 is proportional to the value of the products in the particular product combination/association rule represented by that enhanced graphical element 520. Another feature that provides information is the use of a tag 524 with each enhanced graphical element 520, on which the total value may be displayed.

The enhanced graphical elements 520 include subsections 530 organized in the form of a treemap, with each enhanced graphical element 520 being segmented in subsections 530. The size of each subsection 530 represents the individual value of each product in the combination relative to the overall value of the combination represented by the enhanced graphical element 520. That is, larger subsections 530 have a higher price, and contribute more to the total cost of the combination, than smaller subsections 530. Although not shown, if desired, the actual individual product values could be displayed on each subsection 530. FIG. 5 further provides a legend 538, identifying the particular products corresponding to the subsections 530. The product value could be displayed in the legend 538, if desired.

The features of the enhanced graphical elements 520 allow a user to quickly and intuitively analyze the data. For example, even a quick glace at the visualization 500 allows a viewer to quickly focus on the product combinations have the highest total value, through the size of the enhanced graphical elements 520, and combinations having the greatest lift value, and thus higher positions on the visualization 500. The user can further identify the highest value products in the particular combinations, as represented by the relative size of the subsections 530, which may aid in taking action based on the visualization 500, such as choosing to alter the price of an item or the location of the item in the store, in order to increase profits, increase sales, etc.

Previously if a user desired to visualize the above data, the user would need to either resort to having multiple charts on a single dashboard (a combination of line charts, bar charts, etc.) or fit the data on a single chart with multiple-axis or a single chart with multiple-bars or multiple-lines. However, these visualization styles would still fail to explicitly draw attention to insights created through the relative placement of the measures enabled by the visualization 500.

In some visualizations, there may be a large number of objects in the visualization 500. For example, there may be many enhanced graphical elements 520 simultaneously presented in the visualization 500. Having a large number of enhanced graphical elements 520 simultaneously present may make it difficult to determine the values associated with a particular enhanced graphical element 520. Thus, in some examples, a user may choose to zoom in on a portion of the visualization 500. For instance, the user may click with a pointer device, such as a mouse, or otherwise select a “center” of the visualization, and then scroll in or out to zoom the portion of the visualization proximate a cursor in or out. For particular examples, the visualization 500 may represent a zoomed visualization.

In further examples, a user may select, such as by clicking with a pointer device, a particular enhanced graphical element 520. When selected, the visualization 500 may display values associated with the selected enhanced graphical element 520, such as its identity, total value, individual product components, individual product values, and the lift associated with the product combination.

### IV. Second Implementation of Multi-Dimensional Visualizations

Another example of use of the visualization 300 of FIG. 3 involves analysis of the common situation in the retail industry where the loss of sales is a result of being out of stock of a particular item. Lost sales from an item being out of stock remains a challenge for retailers, distributors, and manufacturers, such as in consumer goods industries. Sales managers and others typically desire to understand the out-of-stock situations and the resulting loss-of-sales, even though such an analysis is essentially a rear-view diagnostic. That is, the loss in sales has already occurred by the time the situation is detected. However, the analysis may help prevent or reduce the chance of key items being of out stock in the future.

There are multiple dimensions and measures involved in this loss of sales analysis, including the actual quantity of the stock, the required (forecasted) quantity of stock, the amount of actual sales, the amount of forecasted sales, and the differences—shortage of quantity and loss of sales. Typically, visualizations only represent these differences, often by displaying them on a bar or line chart with multiple axes, one for the shortage of quantity and another for the loss of sales. This type of display can suffer from a number of deficiencies. For example, the dimensions typically differ in their units. While shortage of quantity might be in thousands of units, the equivalent loss of sales might range from millions of dollars for a high-end product to hundreds of dollars for less expensive products. In these situations, the visualization for one metric becomes too small in comparison to the other, making it difficult to conveniently view all the data. Another deficiency from focusing only on the shortage of quantity and the loss of sales is that the four other measures (actual quantity of the stock, required quantity of stock, amount of actual sales, and amount of forecasted sales), which might be of considerable value to decision-makers, are not visualized at all.

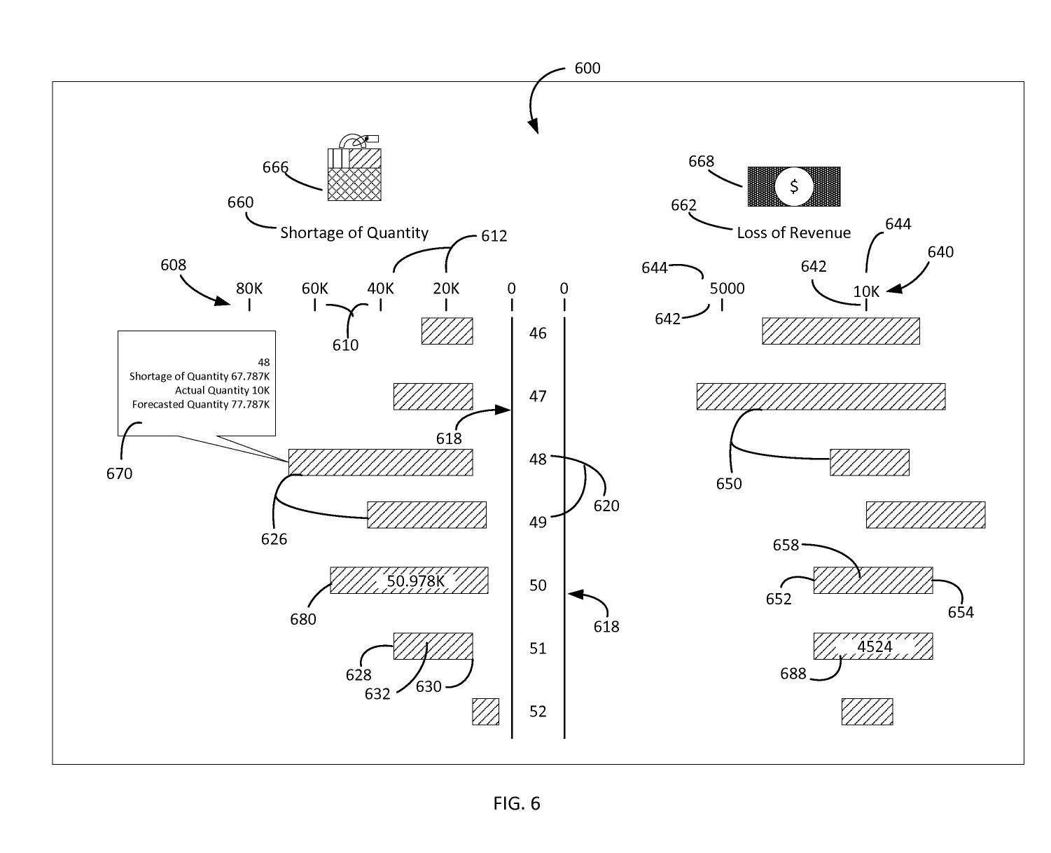

FIG. 6 illustrates a visualization 600 that represents an implementation of visualization 300 of FIG. 3 and provides a significant improvement in visualization of loss of sales associated with out-of-stock situations. Visualization 600 provides a first horizontal axis 608 representing measures associated with quantity. The horizontal axis 608 includes a plurality of tick marks 610 and associated labels 612. Notably, although the horizontal axis 608 extends from right to left, the values increase from left to right, rather than decreasing as is common for horizontal axes when going from right to left. The visualization 600 includes vertical axes 618 having labels 620. Although two axes 618 are shown, a single axis could be displayed if desired. Additionally, although the vertical axes 618 are shown without tick marks, the vertical axes 618 may include tick marks.

Visualization 600 includes multiple horizontal bars 626 representing various measures associated with quantity. Under the first horizontal axis 608, the right edges 628 of the bars 626 represent the actual quantity of the stock during the period of interest. The left edges 630 of the bars 626 represent the forecasted quantity of the stock during the period of interest. The body 632 of the bars 626, extending from the right edges 628 to the left edges 630, represents the shortage of quantity over the period of interest.

A second horizontal axis 640 represents measures associated with revenue. The horizontal axis 640 includes a plurality of tick marks 642 and associated labels 644. The values associated with the labels 644 are shown increasing from left to right. Under the horizontal axis 640 are multiple horizontal bars 650 representing various measures associated with revenue. The left edges 652 of the bars 650 represent the actual value of sales (e.g., in dollars) during the period of interest. The right edges 654 of the bars 650 represent the value of the possible sales (based on the forecasted stock quantity) for the period of interest. The body 658 of the bars 650, extending from the left edges 652 to the right edges 654, represents the value of lost sales over the period of interest.

Visualization 600 includes headings 660, 662 to help orient the viewer to the measures and dimensions being represented. The visualization 600 may further include graphical elements 666, 668 to help orient the viewer. For example, shortage of quantity may be graphically represented by a shopping bag 666, while lost revenue may be represented by a dollar bill 668.

Additional information may be displayed on the visualization 600, either by default or in response to user input. For example, if the user hovers a pointer (cursor) proximate one of the bars 626, 650, the visualization 600 may generate a pop-up window 670, displaying relevant information for the selected bar 626, 650. When the selected bar is a shortage of quantity bar 626, for example, the window 670 may display information such as the identity of the product, the numerical values for shortage of quantity, actual quantity, and forecasted quantity. In this way, the viewer is able to quickly identify qualitative trends from the visualization 600, and, in the same visualization, obtain more detailed, quantitative information.

In a particular example of visualization 600, the bodies 632, 658 of bars 626, 650 display the numerical value of one or more of the relevant measures. For example, bar 680 displays the numerical value of shortage of stock for product ID 50. In more particular examples, the visualization 600 cycles through multiple measures associated with a given bar, such as in response to user input. Bar 680 may, for instance, cycle through values for actual quantity, forecasted quantity, and shortage of quantity in response to selections, such as mouse clicks, from a user input device. Similarly, bar 686 may cycle through displaying quantities relevant to loss of revenue-actual revenue, possible revenue, and lost revenue. Although the numerical value is shown only for bars 680, 686 it should be appreciated that numerical values could be shown for more or all of the bars 626, 650 and cycled according to user input.

In some visualizations, there may be a large number of objects in the visualization 600. For example, there may be many bars 626, 650. Having a large number of bars 626, 650 simultaneously present may make it difficult to determine the values for individual bars 626, 650. Thus, in some examples, a user may choose to zoom in on a portion of the visualization. For instance, the user may click with a pointer device, such as a mouse, or otherwise select a “center” of the visualization, and then scroll in or out to zoom the portion of the visualization proximate a cursor in or out. For particular examples, the visualization 600 may represent a zoomed visualization.

### V. Example Computing Environments

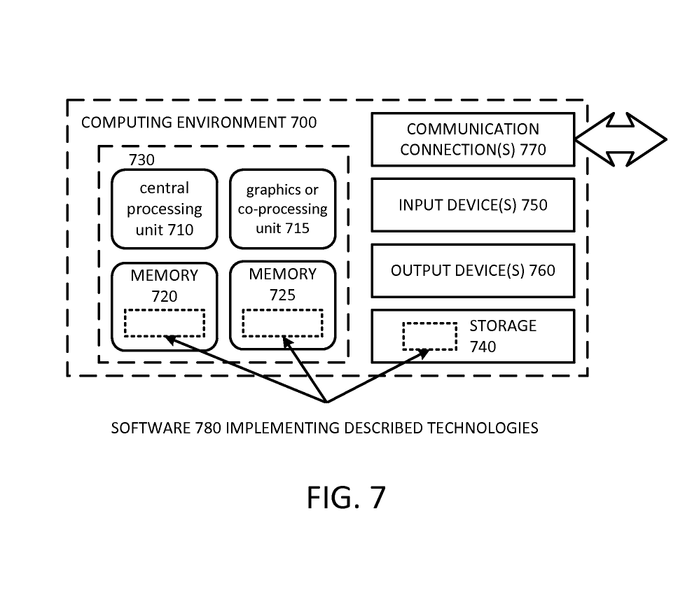

FIG. 7 depicts a generalized example of a suitable computing environment 700 in which the described innovations may be implemented. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, media player, gaming system, mobile device, etc.)

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power.

For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s). For example, memory 720 and 725 and software 780 can store computer-executable instructions for displaying multi-dimensional visualizations.

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

What is claimed is:

1. One or more computer-readable storage media storing computer-executable instructions for:
receiving data representing a plurality of measures; and
generating a data visualization comprising at least a first enhanced graphical element conveying information regarding a first derived measure, a first intrinsic measure, and a second derived measure or a second intrinsic measure among the plurality of measures.

2. The computer-readable storage media of claim 1, wherein conveying information comprises shading, coloring, sizing, or shaping the first enhanced graphical element.

3. The computer-readable storage media of claim 1, wherein the data visualization further comprises at least a second enhanced graphical element, and the placement of the first enhanced graphical element relative to the second enhanced graphical conveys information regarding a measure or dimension of the data.

4. The computer-readable storage media of claim 1, wherein the data visualization conveys an affinity analysis.

5. The computer-readable storage media of claim 4, wherein the first enhanced graphical element represents an association rule and is sized to represent total cost of a plurality of products in the association rule.

6. The computer-readable storage media of claim 4, wherein the first enhanced graphical element comprises a plurality of subsections, each of the plurality of subsections representing a product included in an association rule and sized relative to the other subsections of the plurality of subsections to convey the relative magnitude of individual product cost.

7. The computer-readable storage media of claim 6, wherein the subsections are further visually distinguished from one another though color, shading, patterning, and/or shape.

8. The computer-readable storage media of claim 1, wherein the first enhanced graphical element is positioned on the visualization to convey lift of an association rule.

9. The computer-readable storage media of claim 1, further comprising enlarging a portion of the visualization in response to user input.

10. The computer-readable storage media of claim 1, wherein the visualization conveys loss-of-sales resulting from a stock shortage.

11. The computer-readable storage media of claim 10, wherein the first enhanced graphical element comprises a bar conveying a quantity of actual stock, a quantity of forecasted stock, and a quantity of shortage of stock.

12. The computer-readable storage media of claim 11, further comprising a second enhanced graphical element comprises a bar conveying an amount of actual sales, an amount of possible sales, and an amount of lost sales.

13. The computer-readable storage media of claim 12, further comprising an axis representing product identity, the first and second enhanced graphical elements being positioned proximate one another and the axis such that the visualization conveys sales and stock data for particular products.

14. The computer-readable storage media of claim 12 wherein the first and second enhanced graphical elements are each associated with an axis and both axes convey increasing values relative to a common reference point.

15. The computer-readable storage media of claim 1, further comprising cycling through displaying a series of numerical values associated with the first enhanced graphical element in response to user input.

16. The computer-readable storage media of claim 1, further comprising calculating a derived measure from the data.

17. The computer-readable storage media of claim 1, wherein generating a data visualization is carried out by a visualization engine in communication with a flow control module, the flow control module in communication with a calculation engine, the calculation engine in communication with one or more of metadata storage, an online analytical processing database, and a relational database management system.

18. The computer-readable storage media of claim 17, wherein the flow control module receives queries from the visualization engine, forwards the queries to the calculation engine, and forwards formatted results of the queries to the visualization engine.

19. A computer system comprising a processor and memory that implements an affinity analysis visualization system, the affinity analysis visualization system comprising:
a data repository that stores a plurality of data members, the data members comprising measures associated with the data, including individual product cost of each of a plurality of products; and
a visualization engine that generates a visualization display comprising an enhanced graphical element representing an association rule, the enhanced graphical element being sized to represent total cost of a plurality of products in the association rule and comprising a plurality of visually distinguished subsections, each visually distinguished subsection being sized to represent relative value to total association rule value provided by the respective products from the plurality of products in the association rule, the enhanced graphical element being positioned on the visualization display to convey lift of the association rule.

20. A computer-implemented method of visualizing loss-of-sales, the method comprising:
receiving data representing, for each of a plurality of products, an amount of actual sales, an amount of possible sales, an actual stock quantity, and a forecasted stock quantity; and
generating a data visualization comprising a first enhanced graphical element conveying information for a product of the plurality of products regarding actual sales, possible sales, and lost sales, and a second enhanced graphical element conveying information for the product regarding actual stock, forecasted stock, and stock shortage.
